(19) United States
(12) Patent Application Publication
(10) Pub. No.: US 2008/0135497 A1
(43) Pub. Date: Jun. 12, 2008

(54) Membrane Filter System Comprising Parallel Cross-Flow Filter Modules

(75) Inventors: Werner Fuchs, Wien (AT); Christoph Lukaschek, Wien (AT); Robert Vranitzky, Wien (AT)

Correspondence Address: GREENBLUM & BERNSTEIN, P.L.C., 1950 ROLAND CLARKE PLACE, RESTON, VA, 20191, US

(73) Assignee: Va Tech Wabag GmbH, Wien (AT)

(21) Appl. No.: 10/582,113

(22) PCT Filed: Dec. 1, 2004
(86) PCT No.: PCT/EP04/13602

§ 371 Date: Feb. 5, 2007

(30) Foreign Application Priority Data
Dec. 9, 2003 (AT) A 1965/2003

(51) Int. Cl. C02F 1/00; B01D 63/00

(52) U.S. Cl. 210/767; 210/321.72

(57) ABSTRACT

Membrane filter system having at least one vessel and plurality of individually removable aerated filter modules arranged in the at least one vessel and structured and arranged for a suspension to be filtered to flow through in parallel. At least one filter module has a plurality of membrane units. A plurality of spaces are formed in the at least one vessel by plates arranged cross-wise with respect to a direction of flow through the filter modules. At least one feed space for a common supply of the suspension to be filtered to the plurality of filter modules and at least one permeate space for common discharging of permeate are provided. A feed pump supplies the suspension to be filtered into the at least one feed space. At least one feed distribution space is positioned laterally at least partially around the at least one feed space. Additionally, the at least one feed space has a feed distribution opening and an aeration device around which the suspension to be filtered flows. The feed distribution opening is arranged so suspension to be filtered is guided into the at least one feed space from the at least one feed distribution space cross-wise with respect to the direction of flow through the filter modules.

### CROSS-REFERENCE TO RELATED APPLICATIONS

The present application is a National Stage Application of International Application No. PCT/EP2004/013602 filed Dec. 1, 2004, which published as WO 2005/058464 on Jun. 30, 2005, the disclosure of which is expressly incorporated by reference herein in its entirety. Further, the present application claims priority under 35 U.S.C. § 119 and § 365 of Austrian Patent Application No. A 1965/2003 filed Dec. 9, 2003.

### BACKGROUND OF THE INVENTION

1. Field of the Invention

The invention relates to a membrane filter system, which includes at least one vessel in which there are arranged a plurality of aerated filter modules through which medium can flow in parallel and which can be removed individually from the membrane filter system, at least one filter module comprising a plurality of membrane units and to a method for operating and cleaning a membrane filter system.

2. Description of the Related Art

The Applicant's WO 02/26363 has disclosed a membrane filter system having a filter module, upstream of which there is arranged a gasification unit through which medium can flow. The suspension which is to be purified is fed to the filtration module through a flow pipe. Operation of a plurality of filter modules of this type in parallel, cf. for example JP 2002-210336 A, requires corresponding piping for the individual filter modules, for example in order to remove retentate or permeate obtained from the individual filter modules or to supply the suspension that is to be filtered. This piping has the drawback of taking up large amounts of space and therefore imposing limits on the number of filter modules which can be accommodated within a defined area.

Therefore, it is an aim of the invention to provide a membrane filter system in which the drawbacks of known devices are avoided, and in particular a more tightly packed arrangement of filter modules is possible.

According to the invention, a membrane filter system includes at least one vessel divided into a plurality of spaces by plates arranged normally with respect to the direction of flow through the filter modules, at least one space serving for the common supply of suspension that is to be filtered to the plurality of filter modules, for the common discharging of retentate or for the common discharging of permeate.

On account of the fact that no piping is required to tap off the permeate and/or the retentate and/or to supply suspension that is to be filtered (feed) since the permeate emerges into the space between the filter modules without piping and is extracted from there and/or feed is pumped from a feed space direct to the filter modules and/or retentate emerges directly from the filter modules into a retentate space, it is possible for the filter modules to be brought closer together.

Suitable membrane units include in particular membrane tubes, cushion membranes, hollow fiber membranes or plate membranes.

To obtain a simple supply of the suspension that is to be filtered to the filter modules, it is possible to form a feed space which encloses at least the inlet-side end faces of all the filter modules and is connected to the individual filter modules for the purpose of feeding in suspension that is to be filtered.

To obtain simple removal of the retentate, it is possible to form a retentate space which encloses at least the outlet-side end faces of all the filter modules and is connected to the individual filter modules for removing retentate.

The feed space should be fed uniformly with suspension, which can be achieved by connecting an antechamber used to calm the flow (feed distribution space) upstream of the feed space, which antechamber runs at least partially around the feed space, it being possible for suspension that is to be filtered to penetrate into the feed space from the supply line along the feed space. This can be achieved by a feed distribution opening, which is continuous in the circumferential direction of the feed space, in the lower region of the feed space.

In the case of a dry arrangement of the membrane filter system, the retentate should be removed uniformly from the retentate space, which can be achieved by the retentate space having at least one discharge line.

If the membrane filter system is placed directly in the suspension that is to be filtered, there is no need for a retentate space. The retentate mixes with the suspension surrounding it after it has left the filter modules.

To generate a turbulent flow in the membrane units, e.g. membrane tubes, it is possible for aeration elements which enrich the suspension that is to be filtered with gas bubbles before it enters the filter modules, to be arranged in the feed space.

To enable deposited contaminants to be removed from the feed space of the membrane filter system, it is advantageous to provide a tap-off device, for example a tap-off tube, in the feed distribution space.

The invention makes it possible to ensure substantially unrestricted operation as well as an optimum filtration power and a high efficiency of the filter system.

### BRIEF DESCRIPTION OF THE DRAWINGS

The invention is explained with reference to the appended FIGS. 1 and 2, which diagrammatically depict, by way of example, a membrane filter system according to the invention, and the following descriptions. In the drawings:

FIG. 1 shows a membrane filter system with retentate space (for dry mounting); and

FIG. 2 shows a membrane filter system without retentate space (for immersed mounting).

### DETAILED DESCRIPTION OF THE INVENTION

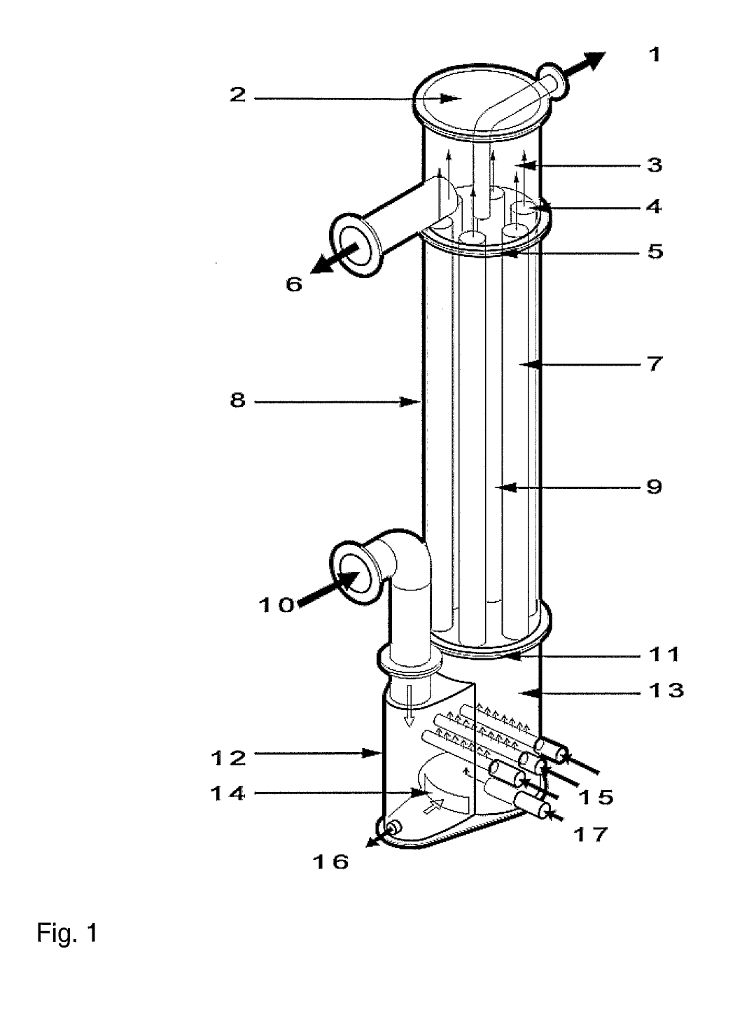

It can be seen from FIG. 1 that the filter modules 7 through which medium flows in the direction of flow are arranged parallel and vertical in the permeate space 9, which is sealed off with respect to the feed side. On the inside, this sealed permeate space 9 forms a common permeate space for the filter modules 7, which is connected to a permeate suction pump or to a permeate back-flushing line via a permeate line 1. The permeate space 9 is only in communication with the outside, towards the suspension that is to be filtered, via the membrane surface of the filter modules 7.

To provide a uniform feed of the suspension that is to be filtered to a large number of filter modules 7 connected in parallel, it is necessary for the incoming flow to be laminar as far as possible. A distribution chamber (feed distribution space) 12 which passes the suspension that is to be filtered through a feed distribution opening 14 arranged in the vicinity of the bottom into the feed space 13, is intended to allow uniform incoming flow to all the filter modules 7.

The gasification which is advantageous for the filtration is achieved by aeration elements 15 positioned in the feed space 13 beneath the filter modules. The aeration pipes illustrated can be used for this purpose, although other aeration elements are also possible.

To ensure a uniform distribution of gas and suspension over all the small membrane tubes of the filter modules 7, the suspension that is to be filtered has to be mixed with the gas phase in such a way as to ensure optimum distribution over the entire flow tube cross section of the membrane module 8, with the result that sufficient and equal turbulence is realized in each filter module 7. The gasification causes what is referred to as the mammoth pump effect, which assists with the forced transfer of flow and therefore saves energy costs. The aeration elements 15 should produce gasification with medium-sized bubbles in the medium that is to be aerated. For example, for a filtration module 7 with tubular membranes with a diameter of 5 mm, a bubble size of approx. 5 mm should be the aim. One example of a use of a filter module 7 could be a tubular tube module with a diameter of 20 cm and length of 3 in. Approximately 600 tube membranes with a diameter of 5 mm are cast into a pressure casing by resin at the top and bottom. Feed space 13 and permeate space 9 are therefore separated from one another in a pressure-tight manner. All the membrane tubes are in communication with one another via the permeate space 9. Permeate can be extracted and/or back-flushed from the permeate space 9 via openings in the pressure casing of the filter module 7.

After it has flowed through the membranes, the retentate passes into a retentate space 3. This retentate space encloses the top of the membrane filter system and is closed off by the retentate cover 2. A tap-off pipe 16 for emptying the membrane filter system is provided at the lowest possible point in the feed distribution space 12. However, the tap-off pipe 16 could also be provided in the feed space 13.

Reliable operation in the long term can only be ensured by completely homogeneous supply to the feed side of the membrane modules. Filtration modules which are insufficiently supplied with cross-flow (slurry and/or air) have a tendency towards excessive build-up of filter cake at the membrane surface. In the most serious circumstances, this filter cake may completely block individual membrane tubes, resulting in an irreversible loss of membrane surface area.

Operating faults often occur in filter systems as a result of plugs formed by hairs, fibers or other contaminants. The cross-flows cause these plugs to be deposited at the locations where the passage width is smallest. Since in the majority of the configurations of the system these locations are formed by the feed passage of the filter modules 7, the contaminants accumulate there. Ever larger conglomerates build up as a result of turbulence. The controlled drainage of the suspension out of the overall membrane filter system combined, at the same time, with back-flushing makes it possible to reliably remedy this problem, since the conglomerated contaminants are in this way discharged from the membrane filter system. In the case of suspensions with a high level of contaminants, it is advantageous for the suspension which is tapped off from the tap-off pipe 16 to have the contaminants removed from it via an external screen, and then for this suspension to be fed back into the filtration circuit.

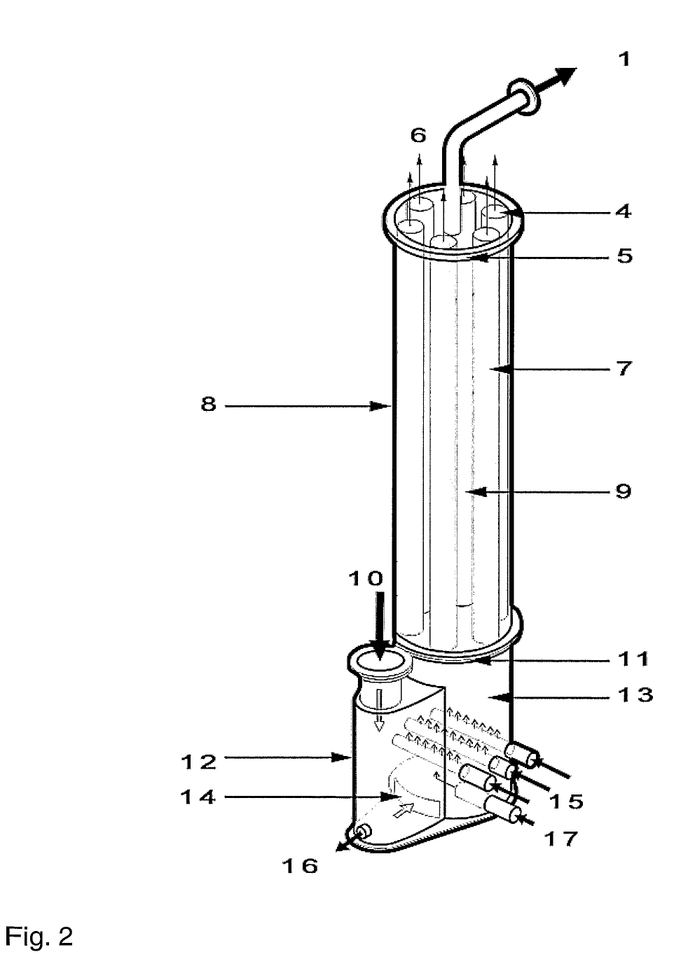

The overall membrane filter system may be in a dry arrangement, i.e. outside a filtration tank. However, as illustrated in FIG. 2, an immersed variant is also possible, since the membrane filter system is, after all, closed off with respect to the outside. In this case, the feed pump can deliver direct from the suspension vessel into the feed distribution space 12. In the immersed embodiment, the retentate space 3 is actually obsolete. The retentate becomes mixed with the suspension after leaving the filter modules. A permeate space 3 that can be blocked off may be required only in the case of chemical purification steps with the exclusion of suspension (cf. Chemische Reinigung [Chemical Purification]). Another possible option for the hydraulic separation of suspension vessel and retentate space is lowering of the suspension vessel level. This can be achieved by slightly concentrating the suspension by the filtration unit.

A plurality of membrane filter systems can be arranged next to one another without any connection or may also be connected to one another, for example by virtue of them having a common permeate buffer tank.

It is necessary to exchange or carry out maintenance on 5 the filter modules after relatively long intervals of time. For this purpose, the feed space 13 and the retentate space 3 are connected to the membrane part. via flange 5 and flange 11. Maintenance or exchange can be carried out on the membrane module 8 by opening these connections.

During filtration, a suspension pump, which is not shown, and a fan, which is likewise not shown, (via the aeration device 15) produce cross-flow over the membrane surface in the filter modules 7 in order to control the build-up of a covering layer resulting from the formation of filter cakes. A permeate suction pump delivers the permeate through the membrane into a permeate buffer tank. This production state is interrupted by cleaning measures either at defined, periodic intervals or as a result of defined trans-membrane pressure limits being exceeded.

A number of methods are possible for cleaning the membrane filter system, with different benefits.

A first method, which is very simple to carry out, is characterized in that to clean the membrane filter system, permeate is back-flushed through the permeate line 1 and the membrane surface, counter to the production direction, at periodic intervals of time.

In combination with the gasification unit, it is possible to implement a further highly advantageous cleaning method by at least introducing a cyclical blast of air through the pressure tube (air pulse line) 17 into the filter modules 1 and if appropriate simultaneously back-flushing permeate that has already been obtained through the permeate line 1 and the membrane surface counter to the production direction, in order to clean the membrane filter system. This results in very particularly thorough flushing of the membrane tubes.

The benefits of the individual methods can very particularly advantageously be combined by using a combination of different cleaning methods to clean the membrane filter system.

In the method for removing contaminants described below, the blocking device in the tap-off pipe 16 is opened and a tapping pump is started up. Advantageous removal of the contaminants results if the suspension pump is not running during the tapping phase. This allows particles which otherwise continue to adhere to the inlet openings of the filter modules 7 as a result of the pressure exerted by the flow of suspension to be removed from the feed space 13. A method for the particularly efficient removal of contaminants results from simultaneous back-flushing of the filter modules 7. Permeate, driven by the force of gravity in the feed spaces of the filter modules 7, flows into the feed space 13 and additionally cleans off any contaminants.

Another form of cleaning, the chemical cleaning, of the membrane in the membrane filter system is particularly efficient if it is carried out during exclusion of the suspension that is to be filtered. For this purpose, the blocking devices of the supply passage 10 and the blocking device of the retentate line 6 are closed, and the suspension that is to be filtered is removed from the feed space 13 of the membrane filter system by means of a pump and a tap-off pipe 16 arranged in the vicinity of the base. A flushing step which is initiated by the back-flushing of permeate through the permeate line 1, and which takes place particularly advantageously as a result of the continuous gasification (pressure tube and aeration device 15) with the filtration air, is responsible for initial preliminary cleaning of the membrane surface. The contaminated purging water has to be pumped out. Then, the membrane filter system is filled again, with one or more chemical cleaning solutions being added to the back-flushed permeate by a metering pump. The aeration with filtration air and the observance of a certain reaction time and reaction temperature results in efficient regeneration of the membrane.

It is possible to prevent the membrane tubes from becoming blocked by the various method techniques, such as the permeate back-washing or the air pulsing into the feed space 13 or also the feed line (the flow pipe supplying the suspension). In general, however, the more uniform the supply of feed slurry and filtration air to the parallel filter modules, the more stable the process.

The required turbulent flow is generated, according to the invention, by a circulation pump (suspension pump), which pumps the suspension that is to be filtered through the filter modules 7, and is additionally increased by the gasification, which is of benefit to the economics of a membrane filter system of this type, since this reduces the amount of energy which has to be introduced for the circulation pump, with gas being introduced into the suspension just before it enters the filter module. As an additional effect, as a result of the air being blown into the feed passage, it is possible to enrich the levels of oxygen in the suspension that is to be filtered, on account of the fine bubbles and the high level of turbulence in the membrane tubes, so that in the case of activated sludge some of the quantity of oxygen which is in any case required for the carbon or nitrogen breathing can already have been provided by the filtration.

The method provides for the suspension to be gasified in such a way that the pressure difference Δp between inlet and outlet of the filter module is reduced or drops to zero, after the hydrostatic pressure of the liquid column of the suspension in the filter module has been taken into account. This makes it possible to set the flow in the membrane tubes in such a way that an ideal or at least improved pressure profile is achieved in the membrane tubes, which increases both the efficiency and he reliability of production. The principle of the method has already been explained in WO 02/26363.

In principle, it is possible to use all filter modules with “Inside-Outside Filtration” (the liquid that is to be filtered flows through a defined feed passage which is surrounded by a membrane), such as for example tube modules or cushion modules, in the membrane filter system described. One example of a use, of a filter module could, as mentioned, be a tubular tube module with a diameter of 20 cm and a length of 3 m. Approximately 600 tube membranes with a diameter of approx. 5 mm are cast into a pressure casing by means of resin at the top and bottom. Feed space and permeate space are therefore separated from one another in a pressure-tight manner. All the membrane tubes are in communication with one another via permeate space. Permeate can be extracted and/or back-flushed from the permeate space via openings in the pressure casing.

The pressure casing of tube modules is actually obsolete for use in the membrane filter system described, since it is replaced by the common permeate space for all the modules. If the membrane material of the tube membranes has a limited mechanical stability, damage may easily occur during storage, assembly or dismantling. In this case, or if the pressure casing cannot be omitted on account of only tube modules with an integrated pressure casing being available, the pressure casing at least does not present any obstacle to the process. Depending on the quantity of permeate or back-flush, it may even be appropriate for the pressure casing of the tube membranes to be used, as it were, as a control wall preventing excess local flow through the membrane. Disproportionate removal of permeate or back-flushing result if the tapping or the application to the permeate space takes place via only one permeate line and high flow rates, with associated hydraulic friction losses, occur at the point of entry into the permeate space.

However, the use of filter modules with outside-inside filtration modules (the membrane is immersed in the liquid that is to be filtered and the permeate extracted from hollow fibers or pockets) is also possible, provided that these modules can be fitted in flow pipes. Furthermore, devices for common feed and air supply as well as a communicating permeate space, have to be created.

The membrane filter system according to the invention has the following advantages over conventional arrangements:

A large number of vertically positioned, aerated filtration modules can be operated in parallel without the likelihood of blockages and without the associated interruptions to operation.

The aeration device for mixing the feed stream with gas bubbles allows a uniform supply to a large number of filter modules.

Contaminants which enter the filtration together with the suspension that is to be filtered may, depending on the hydraulic conditions and the configuration of the membrane filtration modules, either settle directly or join together to form larger assemblies through accumulation. In particular fibers which cannot be retained without residues even using complex preliminary cleaning methods lead to disruption to operation in filtration stages. A tap-off pipe at the lowest point in the membrane filter system allows such deposits to be discharged if present. Irreversible loss of membrane surface area can b avoided, and it is thereby possible to ensure uniform flow to all the membrane filtration modules.

Membranes have to be chemically cleaned at different intervals. The most efficient cleaning is in this case to apply chemical cleaner to the entire membrane surface, both from the feed side and the permeate side. However, the liquid that is to be filtered should advantageously be removed from the membrane filter system for this purpose. With the invention described here, it can be separated from the feed tank holding the suspension that is to be filtered by blocking devices. An emptying pump empties the entire apparatus without any residues, then purges it with permeate, followed by cleaning using the appropriate chemical cleaning method. The compact membrane filter system has a relatively small feed-side and permeate-side volume, so that it is possible to reduce the consumption of chemical cleaning agent compared to conventional filtration arrangements.

The compact membrane filter system can be set up even where very little space is available.

The membrane filter system can be either dry or immersed in the liquid that is to be filtered.

On account of its size, the compact membrane filter system is more portable and can be pre-assembled ma factory, resulting in lower final assembly and transport costs.

The compact arrangement of the membrane filter system requires less tube and fitting material for feed, permeate and air lines and therefore also entails lower investment costs than conventional filtration arrangements.

### LIST OF REFERENCE NUMERALS

1. Permeate line
2. Retentate cover
3. Retentate space
4. Filter module end face
5. Retentate space/membrane module flange
6. Retentate line
7. Filter module
8. Membrane module
9. Permeate space
10. Feed line
11. Feed space/membrane module flange
12. Feed distribution space
13. Feed space
14. Feed distribution opening
15. Aeration device
16. Tap-off device
17. Air pulse line

1-13. (canceled)

14. A membrane filter system, comprising:
at least one vessel;
a plurality of individually removable aerated filter modules arranged in the at least one vessel and structured and arranged for a suspension to be filtered to flow through in parallel at least one filter module comprising a plurality of membrane units;
a plurality of spaces formed in the at least one vessel by plates arranged cross-wise with respect to a direction of flow through the filter modules;
at least one feed space for a common supply of the suspension to be filtered to the plurality of filter modules;
at least one permeate space for common discharging of permeate;
a feed pump for supplying the suspension to be filtered into the at least one feed space; and
at least one feed distribution space positioned laterally at least partially around the at least one feed space,
wherein the at least one feed space comprises:
a feed distribution opening; and
an aeration device around which the suspension to be filtered flows, and
wherein the feed distribution opening is arranged so suspension to be filtered is guided into the at least one feed space from the at least one feed distribution space cross-wise with respect to the direction of flow through the filter modules.

15. The system of claim 14, further comprising at least one retentate space for the common discharging of retentate.

16. The system of claim 15, wherein the at least one permeate space surrounds the filter modules and is sealed off from the suspension to be filtered and the retentate, and wherein the permeate emerges into the permeate space from the filter modules.

17. The system of claim 14, wherein each filter module further comprises an inlet-side end face, and the at least one feed space encloses at least the inlet-side end faces of all the filter modules and is connected to the individual filter modules for feeding in the suspension.

18. The system of claim 15, wherein each filter module further comprises an outlet-side end face, and the at least one retentate space encloses at least the outlet-side end faces of all the filter modules and is connected to the individual filter modules for removing retentate.

19. The system of claim 14, wherein the feed distribution space further comprises a tap-off device to at least one of empty the filtration device and remove contaminants.

20. The system of claim 14, wherein the feed space further comprises an air pulse line for introducing an air pulse into the feed space.

21. A method for operating the membrane filter system as claimed in claim 14, wherein a pressure difference between an inlet and an outlet of each membrane filter module is caused by a friction loss of a flow, and wherein a gasification achieves a reduction in a weight of a fluid column of the suspension in the filter module, which compensates for the pressure difference.

22. A method for cleaning the membrane filter system as claimed in claim 14, comprising back-flushing permeate, counter to a production direction, through a membrane surface of the filter modules at periodic intervals in order to clean the membrane filter system.

23. The method as claimed in claim 22, further comprising introducing a cyclical blast of air through an air pulse line into the feed space and into the filter modules in order to clean the membrane filter system.

24. The method as claimed in claim 22, further comprising:
removing the suspension from the feed space;
back-flushing permeate through the filter modules;
at least one of aerating via the aeration device and mixing with one or more chemical cleaning solutions; and
pumping out contaminated flushing water.

25. The system of claim 14, wherein at least one filter module comprises a plurality of identical membrane units.

26. A method of filtering a suspension, comprising:
supplying a suspension to at least one feed space;
aerating the suspension in the at least one feed space;
feeding the suspension through to a plurality of individually removable aerated filter modules arranged in at least one vessel in a direction cross-wise to a direction in which the suspension is supplied to the at least one feed space, whereby a permeate flows into at least one permeate space adjacent the plurality of individually removable aerated filter modules; and
discharging the permeate from the at least one permeate space.

27. The method of claim 26, further comprising:
discharging retentate into at least one retentate space.

28. The method of claim 26, wherein at least one filter module comprises a plurality of membrane units.
